(19) United States
(12) Patent Application Publication
(10) Pub. No.: US 2022/0005654 A1
(43) Pub. Date: Jan. 6, 2022

(54) METHOD FOR PRODUCING A FOIL-BASED PRESSURE SENSOR

(71) Applicant: IEE INTERNATIONAL ELECTRONICS & ENGINEERING S.A., ECHTERNACH (LU)

(72) Inventors: Steffen SCHULER, Nittel (DE); Guenter GOEDERT, Trier (DE); Matthias MASSING, Konz (DE); Raphaël BENNES, Haute Kontz (FR); Klaus-Peter SCHMITZ, Trier (DE); Harald SCHON, Seinsfeld (DE)

(21) Appl. No.: 17/291,902

(22) PCT Filed: Oct. 31, 2019
(86) PCT No.: PCT/EP2019/079875

§ 371 Date: May 6, 2021

(30) Foreign Application Priority Data
Nov. 7, 2018 (LU) LU100982
Dec. 14, 2018 (LU) LU101058

(51) Int. Cl. H01H 13/88; H01H 13/704; H01H 13/79; G01L 1/00

(52) U.S. Cl. CPC H01H 13/88; H01H 13/704; H01H 3/141; G01L 1/005; H01H 13/79

(57) ABSTRACT

A method for producing a foil-based pressure sensor includes the steps of: providing a bottom element with a bottom foil and at least one bottom electrode disposed on the bottom foil; providing a plurality of top elements, each top element having a top foil with at least one top electrode disposed under the top foil, a combined area of the top elements being smaller than an area of the bottom element; and individually positioning and at least indirectly connecting the top elements to the bottom element so that at least one top electrode of each top element is disposed over at least one bottom electrode of the bottom element to form a sensor cell that is adapted to be activated when a pressure on the sensor cell exceeds a turn-on point. The turn-on point is adjusted by selecting a position of a top element from a plurality of positions.

### TECHNICAL FIELD

The invention generally relates to a method for producing a foil-based pressure sensor and to a foil-based pressure sensor.

### BACKGROUND

Modern vehicles are normally equipped with an occupancy detection system that automatically detects the presence of a driver or passenger on a vehicle seat, e.g. as an input for a seatbelt reminder. Apart from capacitive detection systems, there are systems based on pressure sensors which detect the pressure generated by the weight of the person on the vehicle seat. Some of these systems use foil-based pressure sensors. Such sensors commonly comprise an array of individual but electrically connected sensor cells. Each cell comprises a bottom electrode and a top electrode, which can be brought into electrical contact by an external pressure acting on the cell, whereby the cell is activated. The amount of pressure necessary to activate the cell is also referred to as the turn-on point.

The sensor usually consists of three complete i.e. full area foil layers, namely a printed bottom substrate with conductor lines and bottom electrodes, a structured spacer foil with double sided adhesive and a printed top substrate foil with conductor lines and top electrodes. The spacer foil comprises a hole or cut out in which the top and bottom electrodes are disposed. All three foils are laminated in a two-step process on top of each other, so that pressure sensitive cells are formed. Occupant detection sensors as used in car seats consist of an array of (typically 4-10) sensing cells, whereas e.g. 4-50 sensors are placed on a laminated sheet. For lamination, alignment marks can be used for accurate overlay of the three sheets. Due to the process and material tolerances (printing, heating, cutting, lamination, foil shrinkage), however, not all sensor cells will be perfectly aligned, i.e. not all top electrodes are perfectly placed over the bottom electrodes. Overall state-of-the-art tolerance is in the range of 0.75 mm. This leads to a broad distribution of turn-on points, which is around 5-10 mbar shift per 0.1 mm displacement of top versus bottom electrode. For some applications, however, the turn-on point within cells of a sensor array should be as reproducible as possible to ensure proper activation of the sensor e.g. in a car seat environment to reliably detect presence of a person, versus non-detecting of objects on the car seat.

In some situations, it is necessary to adapt the turn-on point of specific sensor cells in a pressure sensor without changing the overall configuration of the sensor, for example when there are different variants of a vehicle seat with different seat cushions. According to prior art, modification of the turn-on point with a given set of materials is usually done by changing the dimensions of the spacer hole or the foil thicknesses, i.e. changing either the cell design or the used materials. Therefore, a redesign of the spacer foil and/or the top foil is necessary even to adapt the turn-on point of a single cell.

### SUMMARY

It is thus an object of the present invention to facilitate accurate setting of the turn-on point of a sensor cell in a foil-based pressure sensor.

This problem may be solved by a method and sensor according to the claims.

In one aspect, the invention provides a method for producing a foil-based pressure sensor. The sensor can be used for various applications, e.g. it can be used for an occupancy detection system in a vehicle like a car. The sensor is pressure-sensitive, which means that pressure acting on the sensor can be electrically detected. This normally does not mean that the exact amount of pressure can be detected.

In one step of the method, a bottom element is provided, which bottom element comprises a bottom foil and at least one bottom electrode disposed on the bottom foil. The bottom element can also be referred to as a substrate element, base element or the like. Terms like “bottom”, “top”, “horizontal” and “vertical” refer to a reference system where the pressure to be detected is acting vertically downwards on the pressure sensor, which extends at least locally along a horizontal plane. However, the vertical direction as mentioned here does not have to correspond to the direction of gravity and that the sensor in its entirety does not have to be planar but could be curved or bent at least in some portions. Therefore, to be more general, the horizontal plane can be referred to as a (possibly non-planar) “sensor surface” or “tangential surface” and the vertical direction can be referred to as a “normal direction” that is locally perpendicular to the sensor surface. The bottom foil is normally made of electrically isolating material like plastic, rubber, silicone or the like. In particular, it may be an elastic material. The thickness of the bottom foil may vary based on the application, but is usually in the range of 0.01-0.5 mm. Due to the low thickness and possibly due to the material properties of the bottom foil, the bottom element is normally flexible. At least one bottom electrode is disposed on the bottom foil, i.e. the respective bottom electrode is at least partially disposed on an upper side of the bottom foil. The bottom electrode could be printed on the bottom electrode e.g. as conductive ink material or it could be a metal foil attached to the upper surface of the bottom electrode. There are further options for providing the bottom electrode(s). Normally, the thickness of the respective bottom electrode is smaller than the thickness of the bottom foil. While reference is made to at least one bottom electrode, the bottom element normally comprises at least two bottom electrodes.

In another step of the method, a plurality of top elements are provided, each top element comprising a top foil with at least one top electrode disposed under the top foil, a combined area of the top elements being smaller than an area of the bottom element. The top foil may be made of the same materials that can be used for the bottom foil and its thickness may be similar or equal to that of the bottom foil. Likewise, the top electrodes can be made of the same materials that can be used for the bottom electrode(s). The respective top electrode is disposed under the top foil, i.e. it is at least partially disposed on an underside of the top foil, referring to the orientation of the top element in the assembled sensor. A combined area or total area of the top elements is smaller than an area the bottom element. In this context, the area is measured along the surface of the respective top foil or bottom foil. Since their combined area is smaller, all top elements combined cannot completely cover the bottom element.

In another step, the top elements are individually positioned and at least indirectly connected to the bottom element so that at least one top electrode of each top element is disposed over at least one bottom electrode of the bottom element to form a sensor cell that is adapted to be activated when a pressure on the sensor cell exceeds a turn-on point. The top elements are individually positioned on the bottom element, which includes the possibility that all top elements are positioned simultaneously, but their positions can be selected or determined independently of each other. When each bottom element is positioned, it is either directly or indirectly (i.e. via an interposed element) connected to the bottom element. Normally, the top elements are disposed in an offset manner so that they do not overlap pairwise. The connection method is generally not limited but normally comprises laminating or gluing, possibly using an elevated temperature. Positioning and connecting is performed so that at least one top electrode is disposed over at least one bottom electrode.

By connecting the top element to the bottom element, a sensor cell is formed. It is also possible that a plurality of sensor cells are formed using a single top element, but this is usually not preferred. Since there is at least one sensor cell for each of the plurality of top elements, there is also a plurality of sensor cells. Each sensor cell is activated when a pressure acting on it, or more specifically, on the top element, exceeds a turn-on point. When the sensor cell is activated, this can be electrically detected. In some embodiments, only simultaneous activation of a plurality of sensor cells may be detectable. Normally, at least one top electrode is spaced apart from at least one bottom electrode when the pressure is below the turn-on point but is in electrical contact with the bottom electrode when the pressure exceeds the turn-on point. However, the invention is not limited to this working principle. For example, the sensor cell may comprise two bottom electrodes and a single top electrode which is spaced apart from the bottom electrodes along the vertical direction when the sensor is unloaded, i.e. without any (significant) pressure acting on the sensor cell. When a pressure acts on the top element, the top element is deformed and pushed downwards to the bottom element. When the turn-on point is exceeded, the top electrode is in electrical contact with both bottom electrodes, thereby closing an electrical connection between the bottom electrodes. This electrical connection can be detected. It will be appreciated that the “modular concept” introduced herein can also be extended to other types of foil-based sensors, e.g. to sensors which are based on a capacitance change between top and bottom electrode.

The turn-on point can depend on variety of parameters. In particular, it usually depends on the position of the respective top electrode in relation to the bottom electrode with respect to the horizontal plane (or, more generally, with respect to the sensor surface). This position, which is hereinafter referred to as the “horizontal position”, can be determined with high accuracy since each top element, comprising at least one top electrode, is positioned individually. This greatly differs from prior art where all “upper” electrodes are connected by a single foil which normally has the same area as a bottom element. As explained above, the previously known concept makes it almost impossible to adequately position all electrodes for all sensor cells, mostly due to material tolerances, shrinkage etc. With the inventive concept, however, this is possible since all top elements are positioned individually. Furthermore, the inventive concept helps to reduce the amount of material needed because the combined area of the top elements is smaller than the area of the bottom element. For instance, the top foil is only necessary at the respective sensor cells, while in between the sensor cells the top foil is omitted.

For at least one sensor cell, the turn-on point is adjusted by selecting a position of a top element from a plurality of positions in which the sensor cell works, but which differ by their turn-on point. It is understood that the position of the top element is a position relative to the bottom element. In general, this position may be characterised by the abovementioned (two-dimensional) horizontal position as well as by an orientation about a vertical axis. The turn-on point is adjusted for at least one sensor cell by selecting a position of the top element from a plurality of possible positions. All of these possible positions would result in a working sensor cell, but with different turn-on points for different positions.

Apart from the top and bottom electrodes, the sensor usually requires circuitry for electrically connecting it to external devices like a control unit that determines whether the sensor cells are activated or not. It is highly preferred that the bottom element comprises this circuitry, which may comprise e.g. conductor lines, electrical terminals and/or at least one resistor.

According to one embodiment, the turn-on point of at least one sensor cell is adjusted by selecting one of a plurality of horizontal positions of a top element with respect to the bottom element, in which horizontal positions the sensor cell works, but which differ by their turn-on point. In other words, for this specific sensor cell, there is a plurality of possible horizontal positions in which the sensor cell works, but which differ by their turn-on point. As mentioned above, the horizontal position is a position along the two-dimensional horizontal plane. One of the plurality of possible horizontal positions is selected to adjust the turn-on point. For example, if a top electrode is disposed symmetrically with respect to two bottom electrodes, the turn-on point may be lower than if the same top electrode is disposed non-symmetrically. Therefore, the turn-on point can be tuned for specific requirements, e.g. for different car seats having where the sensor is covered by different foam layers. If the covering foam is softer, the turn-on point should be adjusted to a higher value then if the covering foam is harder. The relation between the horizontal position and the turn-on point can be determined e.g. by a series of experiments.

Preferably, the method comprises connecting at least one top element to the bottom element via at least one spacer element so that the spacer element is interposed between the top foil and the bottom foil. The spacer element is normally made of non-conducting material. For instance, it could at least partially be made of the same materials as the top foil and the bottom foil. It is interposed between the top foil and the bottom foil which includes the possibility that at least portions of the spacer element are not in direct contact with the top foil and/or the bottom foil, but yet another element is interposed. For instance, a portion of a top electrode could be interposed between the top foil and the spacer element. However, the at least one spacer element does not (or at least not fully) cover the area of the electrodes. Therefore, in the vicinity of the electrodes, there is a vertical spacing between the top foil and the bottom foil which more or less corresponds to the thickness of the at least one spacer element. In unloaded state, a vertical spacing between at least one top electrode and at least one bottom electrode may be maintained by the at least one spacer element.

It would be conceivable to position and connect the spacer element to the bottom element before the respective top element is positioned and connected. However, this normally makes the assembly process more complicated. It is therefore preferred that at least one top element is provided with the spacer element being connected to the top foil before the top element is connected to the bottom element. One could also say that the spacer element in this case is part of the top element. The respective top element can be prepared in advance including the spacer element and only needs to be positioned and connected to the bottom element in a relatively simple process. This eliminates any risk of misalignment between the top element and the spacer element, which could also affect the turn-on point.

At least one spacer element may comprise an adhesive material, which adhesive material is bonded to the bottom element to connect the top element to the bottom element. There are various options for employing the adhesive material. One option is that the spacer element in its entirety is made of adhesive material, which is e.g. applied to the top foil by spraying, printing or any suitable method and which is bonded to the bottom element when the top element has been positioned. Another option would be that the spacer element comprises a foil with a double-sided adhesive lining. One side of the lining is used to bond the spacer element to the top foil before positioning the top element and the other side of the lining is used to bond the top element to the bottom element.

Preferably, the spacer element comprises an opening in which at least a portion of a top electrode is disposed. This opening may also be referred to as a cutout that is circumferentially surrounded by material of the spacer element. The opening largely defines the sensor cell as such. At least a portion of the top electrode—and, after assembly of the top element with the bottom element, at least a portion of the bottom electrode—is disposed in the opening. “Disposed inside the opening” may more generally be described as “vertically aligned with the opening”. The shape of the opening is not limited in any way and may be e.g. rectangular, circular or the like. The turn-on point also partially depends on the size and the shape of the opening.

In order to facilitate the positioning process, the bottom element preferably comprises first alignment marks and the first alignment marks are used to determine the position of a top element with respect to the bottom element. In other words, the position of the respective top element with respect to the first alignment marks is taken as a reference for the position of the top element with respect to the bottom element. With respect to the horizontal plane, the first alignment marks are disposed inside the area of the bottom element. The alignment marks could e.g. be haptic marks, but are normally optical marks that may be printed onto the bottom foil. One possibility would be that first alignment marks indicate the optimum position of opposite corners of a (rectangular) top element.

Furthermore, at least one top element may comprise second alignment marks and the first and second alignment marks may be used to determine the position of the top element with respect to the bottom element. With respect to the horizontal plane, the second alignment marks are disposed inside the area of the top element. Again, the second alignment marks are normally optical marks that can be printed onto the top foil. By aligning the first and second alignment marks, the horizontal position of the top elements can be determined easily. This is facilitated by the fact that the top foil is normally transparent or at least translucent, wherefore the first alignment marks are visible even when the top foil is disposed over the bottom foil. If, however, one of several turn-on points is to be selected by selecting a specific horizontal position, this may also be facilitated by the alignment marks. For instance, top element or the bottom element could comprise different alignment marks indicating different positions corresponding to different turn-on points.

As mentioned above, each top electrode may be electrically isolated from the bottom electrodes as long as the sensor is in an unloaded state. However, there could also be a permanent electrical connection between at least one top electrode and one bottom electrode. According to such an embodiment, at least one top element comprises a vertically extending connector element in electrical contact with at least one top electrode, which connector element is brought into contact with at least one bottom electrode by connecting the top element to the bottom element, whereby a permanent electrical connection between the top electrode and the bottom electrode is established. It is understood that the connector element is electrically conductive and establishes, when assembled, a permanent electrical connection between the top electrode and the bottom electrode. In some cases, the connector elements may also be regarded as part of the top electrode.

Since each top element can be individually positioned, independent of the other top elements, there are various possibilities how the sensor can be adapted or customized according to different requirements. According to one embodiment, the inventive method comprises, prior to positioning and connecting a top element to the bottom element, selecting one of a plurality of possible orientations about a vertical axis of the top element with respect to the bottom element. The vertical axis, which more generally may be referred to as the normal axis, is perpendicular to the horizontal plane (or, more generally, the sensor surface). As one of a plurality of orientations about the vertical axis is selected, this means that there are different positions of the top element which differ by a rotation in the horizontal plane. For example, two of these orientations could differ by a 180° rotation. However, the respective angle could also be 90° or even an odd angle. This could on the one hand be used to adapt the turn-on point alternatively or additionally to adapting the horizontal position as described above. On the other hand, this could even be used to establish entirely different switching states. For example, in one orientation, a specific top electrode could be disposed to connect a first and second bottom electrode, while in another orientation, this top electrode is disposed to connect a third and fourth bottom electrode. Again, alignment marks as mentioned above can be used to indicate the proper orientation.

The turn-on point may also be adjusted by selecting one of a first position of a top element, in which at least one top support structure extending downwards from the top foil is disposed vertically opposite at least one bottom support structure extending upwards from the bottom foil and a second position, in which the at least one top support structure and the at least one bottom support structure are horizontally offset to each other. The top support structure and the bottom support structure are normally disposed offset to the at least one spacer element or, if the spacer element comprises an opening, they normally are disposed inside the opening. The combined vertical dimension (i.e. the combined height or combined thickness) of the top and bottom support structure is normally less than the distance between the top foil and the bottom foil. When the first position of the top element is selected, the two support structures are disposed opposite each other along the vertical direction. When the top foil is deformed by pressure, the support structures get into contact even after a relatively small deformation of the top foil. When the support structures get into contact, further deformation of the top foil is only possible under considerable increase of the pressure, which means that the turn-on point is increased. However, in the second position, the first and second support structures are horizontally offset so that under deformation of the top foil, they do not get into contact with each other, which facilitates deforming the top foil. Thus, the turn-on point is lower than in the first position. Normally, the top support structure is disposed in the vicinity of a top electrode and/or the bottom support structure is disposed in the vicinity of a bottom electrode.

One possibility is that the above-mentioned first and second position differ by a horizontal offset of the top element with respect to the bottom element, i.e. that these are different horizontal positions. According to another possibility, the first and second position correspond to different orientations about the vertical axis. For instance, the first position and the second position may differ by a 180° rotation.

Apart from changing the horizontal position or the orientation about the vertical axis of a given top element, the turn-on point can be adjusted by selecting for a given sensor cell one of a plurality of top elements having different properties. This enables production of a sensor according to a modular design, where a given bottom element can be combined with various top elements at least one sensor cell and possibly for all sensor cells. The great advantage is that if the turn-on point for only one or only some sensor cells needs to be adapted, this can be done easily by choosing the appropriate top modules for these sensor cell(s), while the top modules for the remaining sensors cell(s) stay the same. Usually the different top elements have different mechanical properties which influence the turn-on point.

There are numerous possibilities how the turn-on point can be influenced by the properties of the top elements. For example, the spacer elements of the top elements could have openings with different sizes and/or shapes. Another example would be that the top elements have top support structures of different numbers, sizes and/or materials. Another possibility is that least two top elements have top foils with different flexibility. This flexibility may in particular be due to different thickness of the top foil. Alternatively or additionally, different materials may be used for the top foil.

At least some embodiments of the invention further provide a foil-based pressure sensor. The sensor comprises a bottom element with a bottom foil and at least one bottom electrode disposed on the bottom foil, and a plurality of top elements, each top element comprising a top foil with at least one top electrode disposed under the top foil, a combined area of the top elements being smaller than an area of the bottom element. The top elements are disposed above the bottom element and at least indirectly connected to the bottom element so that at least one top electrode of each top element is disposed over at least one bottom electrode of the bottom element to form a sensor cell that is adapted to be activated when a pressure on the sensor cell exceeds a turn-on point. For at least one sensor cell, a position of a top element is one a plurality of positions in which the sensor cell works, but which differ by their turn-on point. All these terms have been explained above with reference to the inventive method and therefore will not be explained again.

Preferred embodiments of the inventive sensor correspond to those of the inventive method.

### BRIEF DESCRIPTION OF THE DRAWINGS

Further details and advantages of the present invention will be apparent from the following detailed description of not limiting embodiments with reference to the attached drawing, wherein:

FIG. 1 is a perspective view of a first embodiment of an inventive pressure sensor prior to assembly;

FIG. 2 is a top view of a portion of the pressure sensor from FIG. 1;

FIG. 3 is a sectional view along the line III-III in FIG. 2;

FIG. 4 is respective view of a second embodiment of an inventive pressure sensor;

FIG. 5 is a sectional view of along the line of V-V in FIG. 4;

FIG. 6 is top view of a third embodiment of an inventive pressure sensor; and

FIG. 7 is a sectional view according to the line VII-VII in FIG. 6.

### DETAILED DESCRIPTION

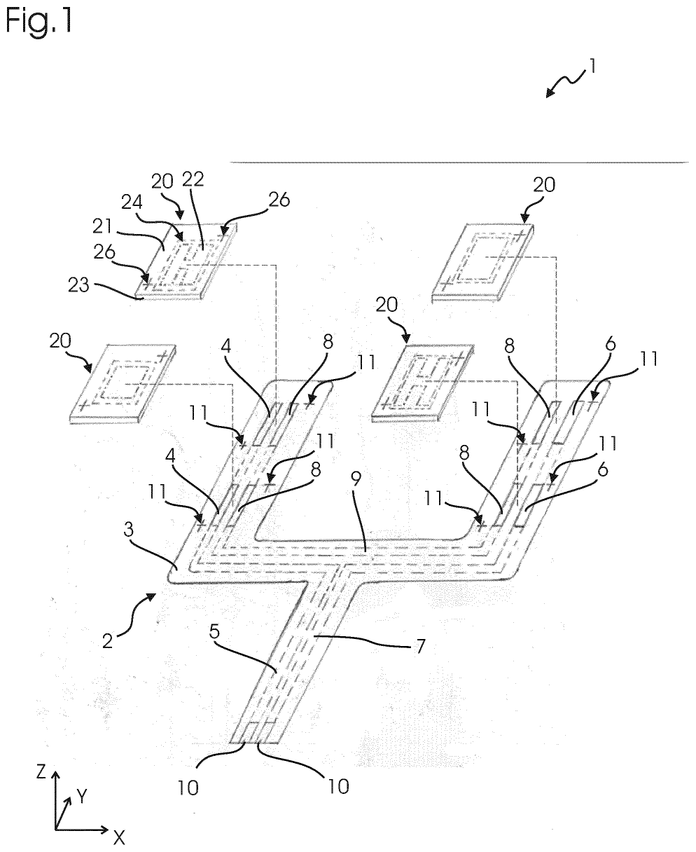

FIGS. 1-3 schematically show a first embodiment of a foil-based pressure sensor 1, which may be used for occupancy detection in a vehicle seat. The sensor 1 comprises a bottom element 2 with a bottom foil 3 that extends in a horizontal plane defined by a first horizontal axis X and a second horizontal axis Y. A vertical axis Z may correspond to the direction of gravity when the sensor 1 is installed in the vehicle seat, but the sensor 1 could also be aligned differently. The bottom foil 3 may e.g. be made of flexible plastic material, silicone or rubber. The bottom element 2 comprises two terminals 10 that are connected to a first conductor path 5 and a second conductor path 7, respectively. The first conductor path 5 connects two first bottom electrodes 4, while the second conductor path 7 connects two second bottom electrodes 6. A third conductor path 9 connects four third bottom electrodes 8. All bottom electrodes 4, 6, 8 are disposed on an upper side of the bottom foil 3 and may e.g. be made of conductive ink printed onto the bottom foil 3 or of metal foil laminated onto the bottom foil 3. Each third bottom electrode 8 is disposed in the vicinity of a first bottom electrode 4 or a second bottom electrode 6, respectively. In this embodiment, the overall shape of the bottom element 2 corresponds to a fork or a letter “Y”, but this is just by way of example.

The sensor 1 further comprises four top elements 20, each of which comprises a top foil 21 that may be made of the same material as the bottom foil 3. A top electrode 22 is disposed on an underside of the top foil 21. Like the bottom electrodes 4, 6, 8, the top electrode 22 may e.g. be made of conductive ink or metal foil. The top foil 21 of each top element 20 has a rectangular shape. On an underside of the top foil 21, each top element 20 comprises a spacer element 23. The spacer element 23 may also be made of flexible plastic, silicone or rubber foil, but normally has a greater thickness along the vertical direction Z than the bottom foil 3 and the top foil 20. The outer dimensions of the spacer element 23 correspond to those of the top foil 21. Each spacer element 23 has a rectangular cutout or opening 24, inside which the respective top electrode 22 is disposed. The top elements 20 are pre-manufactured before they are assembled with the bottom element 2. Each spacer element 23 may comprise a double-sided adhesive lining so that during the manufacturing process of the top elements 20, the spacer element 23 is laminated or bonded to the top foil 20.

To complete the production of the pressure sensor 1, each pre-manufactured top element 20 is positioned on the bottom element 2 and connected thereto by a bonding process using the adhesive lining of the respective spacer element 23. Since the top elements 20 are separate from each other, each of them can be positioned individually, which enables a high degree of precision. To facilitate this precise positioning, the bottom element 2 comprises a plurality of first alignment marks 11 and each top element 20 has corresponding second alignment marks 26. The respective first and second alignment marks 11, 26 are optical marks that are printed on the respective foil 3, 21. The top foil 21 and the spacer element 23 can be transparent or translucent so that the first alignment marks 11 are visible through the top elements 20. By aligning the first and second alignment marks 11, 26 the horizontal position of the respective top element 20 with respect to the bottom element 2 can be adjusted accurately.

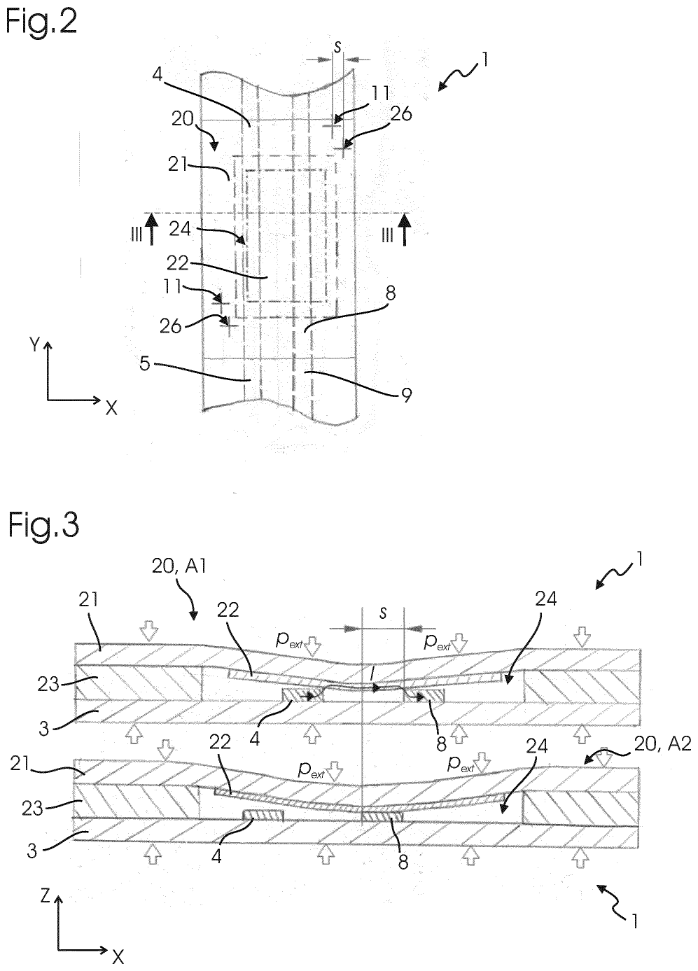

When assembled, each top element 20 together with the bottom element 2 form a sensor cell 30, one of which is shown in FIGS. 2 and 3. The top electrode 22 is disposed over both the first bottom electrode 4 and the third bottom electrode 8. Due to the presence of the spacer element 23, the top electrode 22 is vertically spaced apart from either bottom electrode 4, 8 when no pressure is acting on the sensor cell 30, i.e. when the sensor 1 is in unloaded state. This changes, however, when an external pressure pₑₓₜ exceeds a turn-on point as shown in FIG. 3. The upper part of FIG. 3 shows the top element 20 in a first horizontal position Al with respect to the bottom element 2, in which the top electrode 22 is disposed symmetrically with respect to the bottom electrodes 4, 8. By elastic deformation of the top foil 21, the top electrode 22 is brought into contact with the bottom electrodes 4, 8, thereby establishing an electrical contact so that a current I can flow between the first and third bottom electrode 4, 8. By exceeding the turn-on point, the sensor cell 30 is activated. The lower part of FIG. 3 shows the top element 20 in a second horizontal position A2 with respect to the bottom element 2, in which the top electrode 22 is disposed non-symmetrically with respect to the bottom electrodes 4, 8. The first and second positions A1, A2 differ by a horizontal offset s along the first horizontal axis X. Although the pressure pₑₓₜ and the elastic deformation of the top foil 21 are the same as in the upper part of FIG. 3, the top electrode 20 only makes contact with the third bottom electrodes 8. Since there is no electrical contact between the top electrode 20 and the first bottom electrode 4, the sensor cell 30 is not activated. This is only possible by exceeding a significantly higher turn-on point.

Since the turn-on point can depend on the horizontal position of the top element 20 with respect to the bottom element 2, individual positioning of the top elements 20 allows to accurately determine the turn-on points of their respective sensor cells 30. For example, if the first and second alignment marks 11, 2611, 26 are brought into congruence, this corresponds to a symmetric position of the top electrode 22 with a turn-on point that can be determined in advance by experiments. However, if the first and second alignment marks are horizontally offset from each other, as shown in FIG. 2, this corresponds to a non-symmetric position of the top electrode 22 with a different turn-on point that can also be determined experimentally in advance.

Apart from allowing for an individual positioning of the top elements 20 and an accurate determination of the turn-on point, it is understood that the inventive concept with small, separate top elements 20 leads to a significantly reduced material usage since the top foil 21 and the spacer element 23 are only needed for the area of the top elements 20, which is significantly smaller than the area of the bottom element 2.

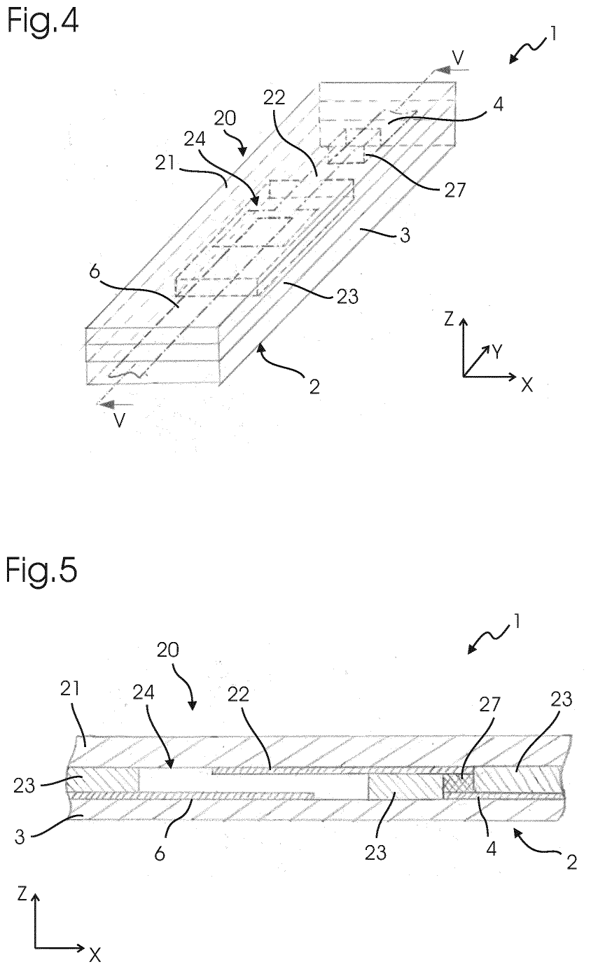

FIGS. 4 and 5 show a second embodiment of a sensor 1 (or rather a portion thereof). In this embodiment, the top electrode 22 extends horizontally beyond the opening 24 in the spacer element 23 and is electrically connected to a connector element 27 that is also a part of the top element 20. The connector element 27 extends vertically downwards from the top electrode 22 and its vertical thickness is chosen so that in assembled state, a permanent electrical connection is established between the top electrode 22 and a first bottom electrode 4, as can be seen in FIG. 5. In the unloaded state, which is shown in FIGS. 4 and 5, the top electrode 22 is disposed vertically spaced apart from a second bottom electrode 6. When a pressure pₑₓₜ acts on the sensor cell 30, the top foil 21 is elastically deformed and when the pressure pₑₓₜ exceeds a turn-on point, an electrical contact is established between the top electrode 22 and the second bottom electrode 6.

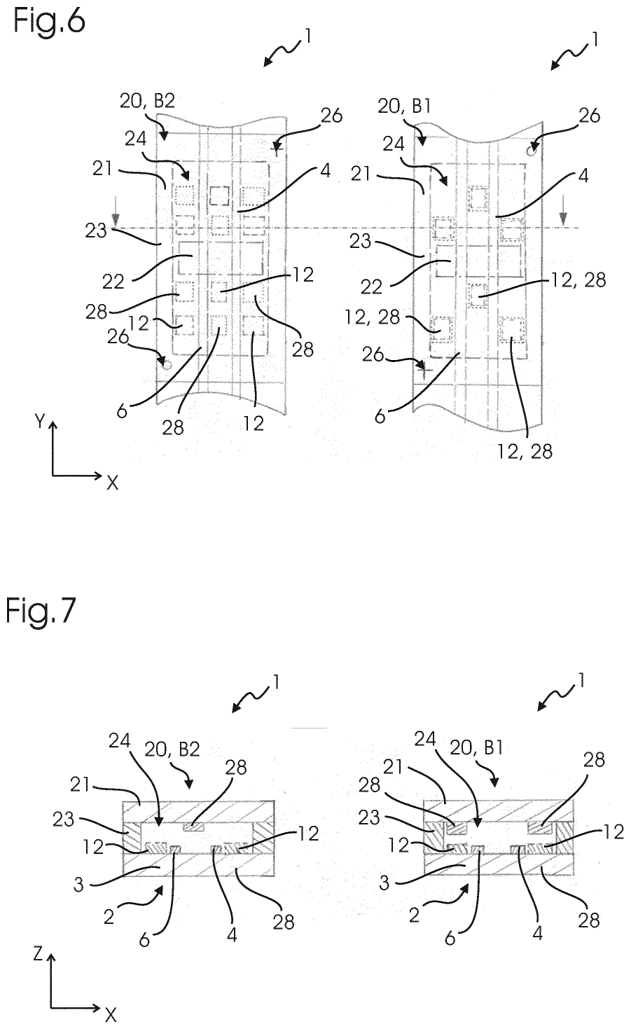

FIGS. 6 and 7 show a third embodiment of a sensor 1 with a sensor cell 30 that is similar to the one shown in FIGS. 2 and 3. However, the top element 20 comprises six top support structures 28 extending downwards from the top foil 21 and the bottom element 2 comprises six corresponding bottom support structures 12. On the one hand, the presence of the top support structures 28 influences the deformed and of the top foil 21, but this effect is normally small if the total area of the top support structures 28 is much smaller than the area of the opening 24. The right side of FIGS. 6 and 7 shows a first orientation B1, each top support structure 28 is disposed vertically opposite a corresponding bottom support structure 12. Therefore, when the top foil 22 is elastically deformed, the top support structures 28 abut the bottom support structures 12 which leads to a significant increase of the stiffness of the sensor cell 30. At this point, the top electrode 22 is still out of contact with the bottom electrodes 4, 6, i.e. the sensor cell 30 is not activated. This is only possible by a significant increase of the pressure pₑₓₜ.

The left side of the FIG. 6 shows a second orientation B2 of the top element 20 about the vertical direction Z, which differs from the first orientation B1 by a rotation of 180° about the vertical axis Z. In this orientation, all top support structures 28 are horizontally offset with respect to the bottom support structures 12. However, when at least one top support structure 28 abuts the bottom element 2 and/or at least one bottom support structure 12 abuts the top element 20, further deformation of the top foil 21 is only possible with significantly increased pressure pₑₓₜ. However, this occurs at a significantly greater deformation than in the first orientation B1. By properly adjusting the thickness of the top electrode 22, the bottom electrodes 4, 8 and the top support structure 28, it is possible that the sensor cell 30 is activated before the top support structure 28 gets into contact with the bottom element 2. In other words, the first orientation B1 corresponds to a significantly higher turn-on point than the second orientation B2.

It should be noted that in all shown embodiments, the turn-on point can also be influenced by other parameters. For example, different top elements 20 with different properties could be available for each sensor cell 30. In the production process, one of these top elements 20 can be chosen, thereby influencing of the turn-on point of the sensor cell 30. For example, the top elements 20 could have openings 24 with different shapes and/or sizes. Also, they could have top foils 21 made of different materials or having different thicknesses.

1. A method for producing a foil-based pressure sensor, comprising:
providing a bottom element with a bottom foil and at least one bottom electrode disposed on the bottom foil,
providing a plurality of top elements, each top element comprising a top foil with at least one top electrode disposed under the top foil, a combined area of the top elements being smaller than an area of the bottom element,
individually positioning and at least indirectly connecting the top elements to the bottom element so that at least one top electrode of each top element is disposed over at least one bottom electrode of the bottom element to form a sensor cell that is adapted to be activated when a pressure on the sensor cell exceeds a turn-on point, wherein, for at least one sensor cell, the turn-on point is adjusted by selecting a position of a top element from a plurality of positions in which the sensor cell works, but which differ by their turn-on point.

2. A method according to claim 1, wherein the turn-on point of at least one sensor cell is adjusted by selecting one of a plurality of horizontal positions of a top element with respect to the bottom element, in which horizontal positions the sensor cell works, but which differ by their turn-on point.

3. A method according to claim 1, further comprising connecting at least one top element to the bottom element via at least one spacer element so that the spacer element is interposed between the top foil and the bottom foil.

4. A method according to claim 1, wherein at least one top element is provided with the spacer element being connected to the top foil before the top element is connected to the bottom element.

5. A method according to claim 1, wherein at least one spacer element comprises an adhesive material, which adhesive material is bonded to the bottom element to connect the top element to the bottom element.

6. A method according to claim 1, wherein the spacer element comprises an opening in which at least a portion of the at least one top electrode is disposed.

7. A method according to claim 1, wherein the bottom element comprises first alignment marks and the first alignment marks are used to determine the position of a top element with respect to the bottom element.

8. A method according to claim 7, wherein at least one top element comprises second alignment marks and the first and second alignment marks are used to determine the position of the top element with respect to the bottom element.

9. A method according to claim 1, wherein at least one top element comprises a vertically extending connector element in electrical contact with at least one top electrode, which connector element is brought into contact with at least one bottom electrode by connecting the top element to the bottom element, whereby a permanent electrical connection between the top electrode and the bottom electrode is established.

10. A method according to claim 1, further comprising, prior to positioning and connecting a top element to the bottom element, selecting one of a plurality of possible orientations about a vertical axis of the top element with respect to the bottom element.

11. A method according to claim 1, wherein the turn-on point is adjusted by selecting one of a first position of a top element, in which at least one top support structure extending downwards from the top foil in the vicinity of a top electrode is disposed vertically opposite at least one bottom support structure extending upwards from the bottom foil in the vicinity of a bottom electrode and a second position, in which the at least one top support structure and the at least one bottom support structure are horizontally offset to each other.

12. A method according to claim 11, wherein the first and second position correspond to different orientations about the vertical axis.

13. A method according to claim 1, wherein the turn-on point is adjusted by selecting for a given sensor cell one of a plurality of top elements having different properties.

14. A method according to claim 13, wherein at least two top elements have top foils with different flexibility.

15. A foil-based pressure sensor, comprising:
a bottom element with a bottom foil and at least one bottom electrode disposed on the bottom foil, and
a plurality of top elements, each top element comprising a top foil with at least one top electrode disposed under the top foil, a combined area of the top elements being smaller than an area of the bottom element
wherein the top elements are disposed above the bottom element and at least indirectly connected to the bottom element so that at least one top electrode of each top element is disposed over at least one bottom electrode of the bottom element to form a sensor cell that is adapted to be activated when a pressure on the sensor cell exceeds a turn-on point, and, for at least one sensor cell, a position of a top element is selected from a plurality of positions in which the sensor cell works, but which differ by their turn-on point.
